(19) United States
(12) Patent Application Publication
(10) Pub. No.: US 2025/0390324 A1
(43) Pub. Date: Dec. 25, 2025

(54) User-Specific Navigation Guidance Generation

(71) Applicant: ServiceNow, Inc., Santa Clara, CA (US)

(72) Inventors: Aditya Ramamurthy, Hyderabad (IN); Ravindra Sunkaranam, Hyderabad (IN); Sathi Babu Peddada, Hyderabad (IN); Akash Kumar, Hyderabad (IN); Dinesh Lodhi, Hyderabad (IN); Hari Teja Varma Jampana, Hydrabad (IN)

(21) Appl. No.: 18/753,846

(22) Filed: Jun. 25, 2024

(51) Int. Cl. G06F 9/451

(52) U.S. Cl. CPC G06F 9/453

(57) ABSTRACT

Embodiments are provided to provide for automated generation of guidance for user navigation of workflows. This guidance is provided as a user exhibits uncertainty with respect to the next step in their navigation, reducing wasted time and computational resources in incorrectly navigating the workflow, repeatedly cycling through portions of the workflow, or cancelling and restarting navigation of the workflow. Records of past navigations of the workflow that match the current navigation are identified and used to determine one or more suggested navigation steps to the user. The suggested step is then indicated to the user within their navigation of the workflow, avoiding waste related to the user changing contexts or otherwise consulting separate tutorial resources. Generating guidance on the fly based on recent workflow navigation steps avoids the computational and memory costs associated with pre-computing guidance across all, or a very large number of, possible navigations of the workflow.

### BACKGROUND

Certain user interfaces (UIs) enable a user to enter and track goals for the user to complete. A UI may include references to documentation relevant to a user's goals. However, user interactions with this UI typically includes the user discarding progress towards a goal or switching to another UI to locate relevant documentation. As a consequence, utilization of computing resources (e.g., processing, bandwidth, and memory capacity) is relatively high, as a user may navigate through several paths in a workflow that are not relevant to a corresponding goal.

### SUMMARY

The current disclosure is aimed at a system and method that provides real time machine-generated contextual help tailored to a user's specific current pattern of operations. Further, the system includes a graphical user interface (or other workflow interface) that is provided to a user while navigating the interface. In some implementations, the system provides the contextual help in response to determining that the user is experiencing difficulty navigating the interface. This allows the user to avoid spending additional computational resources (e.g., processing, memory, and/or bandwidth capacity) interacting with the interface in an incorrect or inefficient manner (e.g., following false or unnecessary paths through a workflow) or even failing to accomplish their goal entirely. The embodiments described herein also improve the effectiveness of such interfaces by detecting that a user requires guidance while they are using the interface and providing that guidance within the interface, without requiring the user to expend additional computational resources by accessing a separate system (e.g., knowledgebase via another browser or other system) and/or by leaving the interface, thereby sacrificing progress already made toward the goal.

In some implementations, the system records a user's ongoing interactions with a graphical user interface or other workflow interface. Based on the pattern of the user's recorded navigation of the workflow (e.g., a rate of interactions, a delay of more than a threshold time, a pattern of navigating from a starting page to a number of different pages and then returning to the starting page), the system may determine that the user is experiencing difficulty. In some implementations, the system determines that the user is experiencing difficulty by determining that the user's navigation of the workflow meets an inefficiency criterion. For example, the inefficiency criterion may include detecting that the user has paused for more than a set period of time, that the user has begun to interact with a ‘cancel’ or ‘back’ button, that the user has clicked a ‘help’ button of the user interface, or some other determination.

In response to determining that the user is experiencing difficulty, the system may obtain a subset of stored logs of prior navigations the workflow (which meet an efficiency criterion). Such logs can be obtained by, e.g., recording information about prior user interactions with the system via a graphical user interface. The system may then use the subset of the stored logs to generate navigation information related to the workflow (e.g., a suggested interface element to click or otherwise interact with, and/or text providing context for that interaction). In some implementations, the system implements a natural language model to generate the navigation information using the stored logs. The navigation information could then be provided to the user as one or more modal outputs.

In this way, the excess amount of time and computational resources used by the user inefficiently navigating the workflow can be reduced by providing guidance as soon as the user begins to exhibit such inefficiency (i.e., when the user is experiencing difficulty). Additionally, by using a natural language model to generate the navigation information based on the logs of past sessions, the system can provide navigational feedback even if such relevant feedback was not previously available.

Additionally, the system can provide guidance that is specifically tailored not just to the exact goal or task being pursued by the user, but also to the specific step within the performance of that task that the user has just completed. To do this, the system can search a set of stored logs to identify one or more logs that match the user's current navigation of the workflow with respect to one, two, five, or more prior interactions (e.g., wherein another user interacts with the same elements of the user interface in the same order). Thus, the system can provide guidance that is specific to the exact circumstances the user is currently experiencing (and not, e.g., to a generic tutorial that matches a slightly different, pre-determined set of user interactions). The system can also provide guidance that is keyed to the exact ‘next step’ that the user should take (rather than beginning again from a ‘start’ action of a tutorial).

Accordingly, a first example embodiment may involve a method that includes: (i) obtaining one or more logs indicating navigational information regarding a workflow; (ii) identifying, based on the one or more logs, a portion of the navigational information that satisfies an efficiency criterion; and (iii) generating, from a natural language model and based on the portion of the navigational information, suggested navigation information related to the workflow.

A second example embodiment may involve a non-transitory computer-readable medium, having stored thereon program instructions that, upon execution by a computing system, cause the computing system to perform operations in accordance with any of the previous example embodiments.

In a third example embodiment, a computing system may include at least one processor, as well as memory and program instructions. The program instructions may be stored in the memory, and upon execution by the at least one processor, cause the computing system to perform operations in accordance with any of the previous example embodiments.

In a fourth example embodiment, a system may include various means for carrying out each of the operations of any of the previous example embodiments.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5 depicts another communication environment involving a remote network management architecture, in accordance with example embodiments.

FIG. 6A depicts a graphical user interface, in accordance with example embodiments.

FIG. 6B depicts a graphical user interface, in accordance with example embodiments.

FIG. 7A depicts a graphical user interface, in accordance with example embodiments.

FIG. 7B depicts a graphical user interface, in accordance with example embodiments.

FIG. 8 depicts navigations of a workflow, in accordance with example embodiments.

FIG. 9 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein. Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Unless clearly indicated otherwise herein, the term “or” is to be interpreted as the inclusive disjunction. For example, the phrase “A, B, or C” is true if any one or more of the arguments A, B, C are true, and is only false if all of A, B, and C are false.

### I. Example Technical Improvements

These embodiments provide a technical solution to a technical problem. One technical problem being solved is reducing waste of processor cycles, bandwidth, and other computational resources due to users' unfamiliarity with a workflow leading to ineffective use thereof (e.g., selecting and then unselecting/retreating from incorrect navigation options, repeated cycles through incorrect or partial workflow navigations, cancelling navigation of a workflow to consult tutorials or other guidance materials). In practice, this is problematic because a user may be unfamiliar with a new workflow (e.g., a new graphical user interface via which to interact with a workflow), a user may be new to the use of a pre-existing workflow, new functionality may be added to an existing workflow, and/or a user may interact with aspects of a workflow that they only infrequently use and may thus be unfamiliar with the workflow, leading to unnecessary navigation through the workflow (e.g., to pages of the workflow that are not relevant to the user's objective(s). Further, each time a user accesses a user interface (e.g., a web page), multiple computationally expensive database queries may be required to fill out the content of the user interface. By providing navigation guidance to a user while they are navigating the workflow and prior to their making missteps in that navigation, the embodiments herein can reduce the computational cost of such inefficient navigation.

In other techniques, pre-programmed tutorials or other guidance materials may be created to provide guidance to users in the navigation of a workflow. However, these techniques require such tutorials to be programmed ahead of time, based on expectations of users' future navigations of the workflow. However, this leaves a great many possible workflow navigations without corresponding pre-generated tutorials (because those particular navigations were not anticipated and/or because a developer did not manually program tutorials therefor). Alternatively, tutorials could be programmatically generated for possible workflow navigations. However, the cost in processor cycles and storage space to instantiate tutorials for all (or nearly all) possible navigation patterns would be extreme for all but the most simple and limited workflows.

Additionally, providing separate tutorials to guide users to navigate a workflow to accomplish various objectives may require the user to search for a relevant tutorial amongst a set of available tutorials, as well as to sacrifice any progress already made in navigating the workflow in order to follow a selected tutorial from its first step and/or to navigate away from the workflow in order to select and/or otherwise interact with the tutorial. This results in wasted processor cycles and/or bandwidth as the user recapitulates already-performed navigation steps.

The embodiments herein overcome these limitations by generating, on the fly and based on a user's specific most recent steps of navigation of a workflow, guidance to continue their navigation. This is accomplished by identifying, from a set of logs of navigation of the workflow, a subset of the logs that satisfy an efficiency criterion and then using a natural language model, based on the subset of the logs, to generate suggested navigation information (e.g., tooltips, modal outputs) to guide the user. In this manner, the guidance can be provided while the user remains within their in-progress navigation of the workflow, avoiding waste associated with, e.g., restarting the navigation to follow a pre-generated tutorial. Additionally, since the guidance is generated based on the user's specific current navigation history (e.g., the most recent two, five, or more steps of the navigation of the workflow), the storage and other computational costs of generating tutorials or other guidance for alternative navigations of the workflow can be avoided. Such costs can be further reduced by only generating navigation guidance (and performing related operations, e.g., identifying sets of past navigation logs that match the user's current navigation with respect to one, two, five, or more prior steps) in response to detecting that the user is exhibiting uncertainty in their navigation of the workflow.

The computational cost of generating guidance can also be reduced by limiting the set of past logs used to generate such guidance to only those logs that satisfy an efficiency criterion and/or that match the user's in-progress navigation of the workflow with respect to two (or more, e.g., five) prior steps. This can reduce the computational cost to generate the guidance by allowing smaller natural language models (e.g., with fewer parameters, with shorter maximum input lengths and/or histories), that require fewer processor cycles and memory to execute and less storage and bandwidth to store and recall, to be used in the generation of such guidance.

Other technical improvements may also flow from these embodiments, and other technical problems may be solved. Thus, this statement of technical improvements is not limiting and instead constitutes examples of advantages that can be realized from the embodiments.

### II. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM), IT service management (ITSM), IT operations management (ITOM), and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) has been introduced to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security. Nonetheless, the embodiments herein are not limited to enterprise applications or environments, and can be more broadly applied.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure. In some cases, applications structured differently than MVC, such as those using unidirectional data flow, may be employed.

The aPaaS system may support standardized application components, such as a standardized set of widgets and/or web components for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HyperText Markup Language (HTML) and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist, including but not limited to metadata-based encodings of web components, and various uses of JAVASCRIPT® Object Notation (JSON) and/or extensible Markup Language (XML) to represent various aspects of a GUI.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### III. Example Computing Devices and Cloud-Based Computing Environments

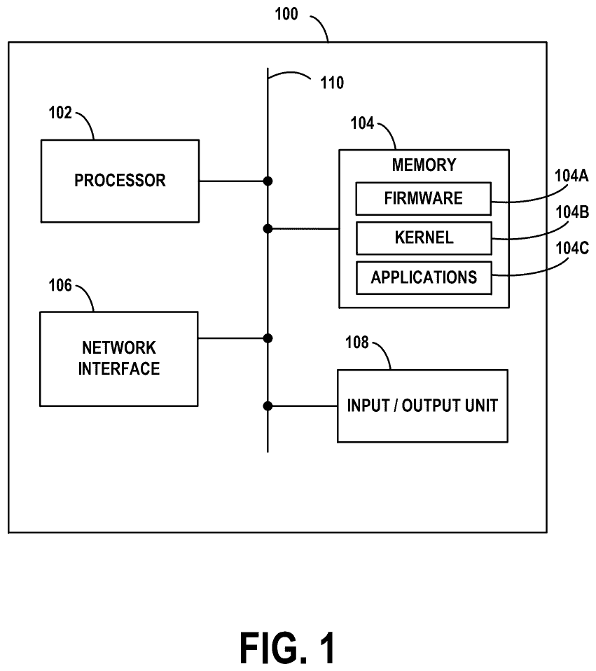

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a graphical processing unit (GPU), another form of co-processor (e.g., a mathematics or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, 10 Gigabit Ethernet, Ethernet over fiber, and so on). Network interface 106 may also support communication over one or more non-Ethernet media, such as coaxial cables or power lines, or over wide-area media, such as Synchronous Optical Networking (SONET), Data Over Cable Service Interface Specification (DOCSIS), or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed. The exact physical location, connectivity, and configuration of these computing devices may be unknown and/or unimportant to client devices. Accordingly, the computing devices may be referred to as “cloud-based” devices that may be housed at various remote data center locations.

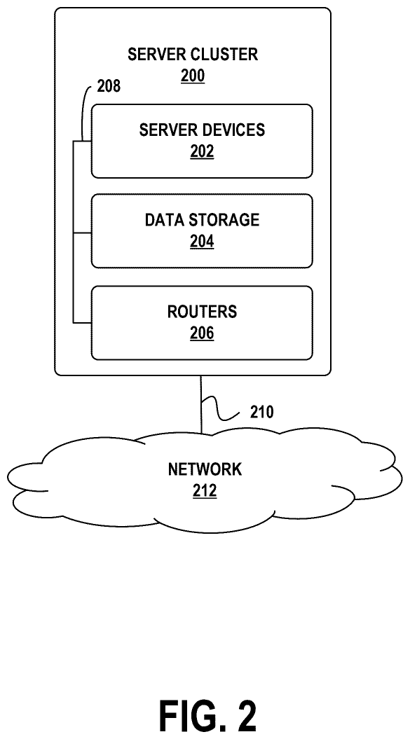

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database or a No-SQL database (e.g., MongoDB). Various types of data structures may store the information in such a database, including but not limited to files, tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as HTML, XML, JSON, or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### IV. Example Remote Network Management Architecture

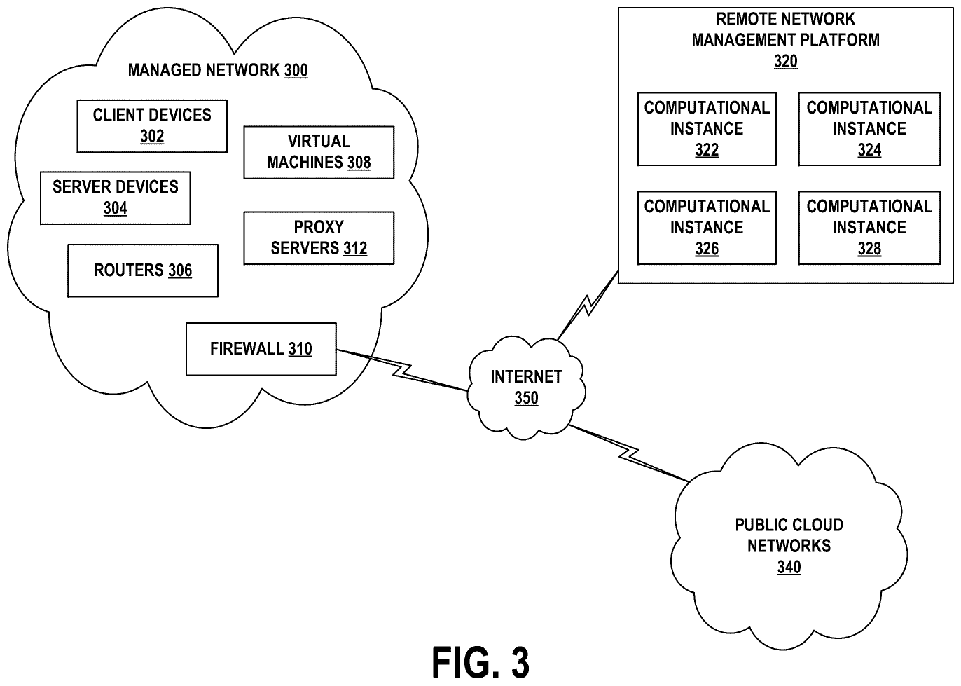

FIG. 3 depicts a remote network management architecture, in accordance with example embodiments. This architecture includes three main components-managed network 300, remote network management platform 320, and public cloud networks 340—all connected by way of Internet 350.

### A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components.

Possibly with the assistance of proxy servers 312, remote network management platform 320 may also be able to discover and manage aspects of public cloud networks 340 that are used by managed network 300. While not shown in FIG. 3, one or more proxy servers 312 may be placed in any of public cloud networks 340 in order to facilitate this discovery and management.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

### B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may affect all customers' data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

### C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include Amazon AWS Cloud, Microsoft Azure Cloud (Azure), Google Cloud Platform (GCP), and IBM Cloud Platform. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

### D. Communication Support and Other Operations

Internet 350 may represent a portion of the global Internet. However, Internet 350 may alternatively represent a different type of network, such as a private wide-area or local-area packet-switched network.

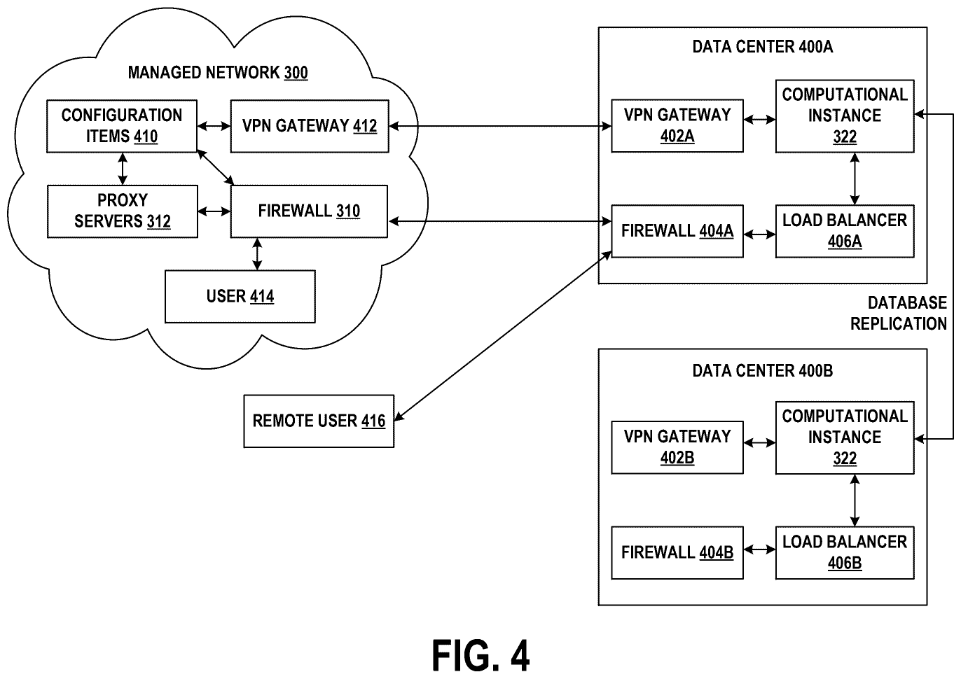

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any components thereof, any applications or services executing thereon, as well as relationships between devices, components, applications, and services. Thus, the term “configuration items” may be shorthand for part of all of any physical or virtual device, or any application or service remotely discoverable or managed by computational instance 322, or relationships between discovered devices, applications, and services. Configuration items may be represented in a configuration management database (CMDB) of computational instance 322.

As stored or transmitted, a configuration item may be a list of attributes that characterize the hardware or software that the configuration item represents. These attributes may include manufacturer, vendor, location, owner, unique identifier, description, network address, operational status, serial number, time of last update, and so on. The class of a configuration item may determine which subset of attributes are present for the configuration item (e.g., software and hardware configuration items may have different lists of attributes).

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively). In various alternatives, devices in managed network 300, such as proxy servers 312, may use a secure protocol (e.g., TLS) to communicate directly with one or more data centers.

### V. Example Discovery

In order for remote network management platform 320 to administer the devices, applications, and services of managed network 300, remote network management platform 320 may first determine what devices are present in managed network 300, the configurations, constituent components, and operational statuses of these devices, and the applications and services provided by the devices. Remote network management platform 320 may also determine the relationships between discovered devices, their components, applications, and services. Representations of these devices, components, applications, and services may be referred to as configuration items.

The process of determining the configuration items and relationships therebetween within managed network 300 is referred to as discovery, and may be facilitated at least in part by proxy servers 312. To that point, proxy servers 312 may relay discovery requests and responses between managed network 300 and remote network management platform 320.

Configuration items and relationships may be stored in a CMDB and/or other locations. Further, configuration items may be of various classes that define their constituent attributes and that exhibit an inheritance structure not unlike object-oriented software modules. For instance, a configuration item class of “server” may inherit all attributes from a configuration item class of “hardware” and also include further server-specific attributes. Likewise, a configuration item class of “LINUX® server” may inherit all attributes from the configuration item class of “server” and also include further LINUX®-specific attributes. Additionally, configuration items may represent other components, such as services, data center infrastructure, software licenses, units of source code, configuration files, and documents.

While this section describes discovery conducted on managed network 300, the same or similar discovery procedures may be used on public cloud networks 340. Thus, in some environments, “discovery” may refer to discovering configuration items and relationships on a managed network and/or one or more public cloud networks.

For purposes of the embodiments herein, an “application” may refer to one or more processes, threads, programs, client software modules, server software modules, or any other software that executes on a device or group of devices. A “service” may refer to a high-level capability provided by one or more applications executing on one or more devices working in conjunction with one another. For example, a web service may involve multiple web application server threads executing on one device and accessing information from a database application that executes on another device.

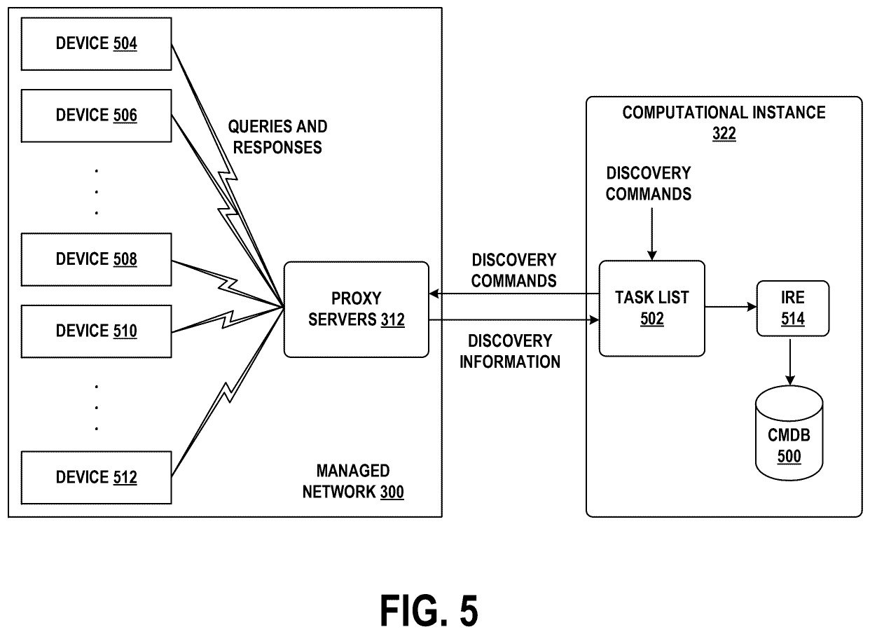

FIG. 5 provides a logical depiction of how configuration items and relationships can be discovered, as well as how information related thereto can be stored. For sake of simplicity, remote network management platform 320, public cloud networks 340, and Internet 350 are not shown.

In FIG. 5, CMDB 500, task list 502, and identification and reconciliation engine (IRE) 514 are disposed and/or operate within computational instance 322. Task list 502 represents a connection point between computational instance 322 and proxy servers 312. Task list 502 may be referred to as a queue, or more particularly as an external communication channel (ECC) queue. Task list 502 may represent not only the queue itself but any associated processing, such as adding, removing, and/or manipulating information in the queue.

As discovery takes place, computational instance 322 may store discovery tasks (jobs) that proxy servers 312 are to perform in task list 502, until proxy servers 312 request these tasks in batches of one or more. Placing the tasks in task list 502 may trigger or otherwise cause proxy servers 312 to begin their discovery operations. For example, proxy servers 312 may poll task list 502 periodically or from time to time, or may be notified of discovery commands in task list 502 in some other fashion. Alternatively or additionally, discovery may be manually triggered or automatically triggered based on triggering events (e.g., discovery may automatically begin once per day at a particular time).

Regardless, computational instance 322 may transmit these discovery commands to proxy servers 312 upon request. For example, proxy servers 312 may repeatedly query task list 502, obtain the next task therein, and perform this task until task list 502 is empty or another stopping condition has been reached. In response to receiving a discovery command, proxy servers 312 may query various devices, components, applications, and/or services in managed network 300 (represented for sake of simplicity in FIG. 5 by devices 504, 506, 508, 510, and 512). These devices, components, applications, and/or services may provide responses relating to their configuration, operation, and/or status to proxy servers 312. In turn, proxy servers 312 may then provide this discovered information to task list 502 (i.e., task list 502 may have an outgoing queue for holding discovery commands until requested by proxy servers 312 as well as an incoming queue for holding the discovery information until it is read).

IRE 514 may be a software module that removes discovery information from task list 502 and formulates this discovery information into configuration items (e.g., representing devices, components, applications, and/or services discovered on managed network 300) as well as relationships therebetween. Then, IRE 514 may provide these configuration items and relationships to CMDB 500 for storage therein. The operation of IRE 514 is described in more detail below.

In this fashion, configuration items stored in CMDB 500 represent the environment of managed network 300. As an example, these configuration items may represent a set of physical and/or virtual devices (e.g., client devices, server devices, routers, or virtual machines), applications executing thereon (e.g., web servers, email servers, databases, or storage arrays), as well as services that involve multiple individual configuration items. Relationships may be pairwise definitions of arrangements or dependencies between configuration items.

In order for discovery to take place in the manner described above, proxy servers 312, CMDB 500, and/or one or more credential stores may be configured with credentials for the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

There are two general types of discovery-horizontal and vertical (top-down). Each are discussed below.

### A. Horizontal Discovery

Horizontal discovery is used to scan managed network 300, find devices, components, and/or applications, and then populate CMDB 500 with configuration items representing these devices, components, and/or applications. Horizontal discovery also creates relationships between the configuration items. For instance, this could be a “runs on” relationship between a configuration item representing a software application and a configuration item representing a server device on which it executes. Typically, horizontal discovery is not aware of services and does not create relationships between configuration items based on the services in which they operate.

There are two versions of horizontal discovery. One relies on probes and sensors, while the other also employs patterns. Probes and sensors may be scripts (e.g., written in JAVASCRIPT®) that collect and process discovery information on a device and then update CMDB 500 accordingly. More specifically, probes explore or investigate devices on managed network 300, and sensors parse the discovery information returned from the probes.

Patterns are also scripts that collect data on one or more devices, process it, and update the CMDB. Patterns differ from probes and sensors in that they are written in a specific discovery programming language and are used to conduct detailed discovery procedures on specific devices, components, and/or applications that often cannot be reliably discovered (or discovered at all) by more general probes and sensors. Particularly, patterns may specify a series of operations that define how to discover a particular arrangement of devices, components, and/or applications, what credentials to use, and which CMDB tables to populate with configuration items resulting from this discovery.

Both versions may proceed in four logical phases: scanning, classification, identification, and exploration. Also, both versions may require specification of one or more ranges of IP addresses on managed network 300 for which discovery is to take place. Each phase may involve communication between devices on managed network 300 and proxy servers 312, as well as between proxy servers 312 and task list 502. Some phases may involve storing partial or preliminary configuration items in CMDB 500, which may be updated in a later phase.

In the scanning phase, proxy servers 312 may probe each IP address in the specified range(s) of IP addresses for open Transmission Control Protocol (TCP) and/or User Datagram Protocol (UDP) ports to determine the general type of device and its operating system. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist.

In the classification phase, proxy servers 312 may further probe each discovered device to determine the type of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the specific type of operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 10, as a set of WINDOWS®-10-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500 along with any relevant relationships therebetween. Doing so may involve passing the identification information through IRE 514 to avoid generation of duplicate configuration items, for purposes of disambiguation, and/or to determine the table(s) of CMDB 500 in which the discovery information should be written.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (software applications), and so on. Once more, the discovered information may be stored as one or more configuration items in CMDB 500, as well as relationships.

Running horizontal discovery on certain devices, such as switches and routers, may utilize SNMP. Instead of or in addition to determining a list of running processes or other application-related information, discovery may determine additional subnets known to a router and the operational state of the router's network interfaces (e.g., active, inactive, queue length, number of packets dropped, etc.). The IP addresses of the additional subnets may be candidates for further discovery procedures. Thus, horizontal discovery may progress iteratively or recursively.

Patterns are used only during the identification and exploration phases-under pattern-based discovery, the scanning and classification phases operate as they would if probes and sensors are used. After the classification stage completes, a pattern probe is specified as a probe to use during identification. Then, the pattern probe and the pattern that it specifies are launched.

Patterns support a number of features, by way of the discovery programming language, that are not available or difficult to achieve with discovery using probes and sensors. For example, discovery of devices, components, and/or applications in public cloud networks, as well as configuration file tracking, is much simpler to achieve using pattern-based discovery. Further, these patterns are more easily customized by users than probes and sensors. Additionally, patterns are more focused on specific devices, components, and/or applications and therefore may execute faster than the more general approaches used by probes and sensors.

Once horizontal discovery completes, a configuration item representation of each discovered device, component, and/or application is available in CMDB 500. For example, after discovery, operating system version, hardware configuration, and network configuration details for client devices, server devices, and routers in managed network 300, as well as applications executing thereon, may be stored as configuration items. This collected information may be presented to a user in various ways to allow the user to view the hardware composition and operational status of devices.

Furthermore, CMDB 500 may include entries regarding the relationships between configuration items. More specifically, suppose that a server device includes a number of hardware components (e.g., processors, memory, network interfaces, storage, and file systems), and has several software applications installed or executing thereon. Relationships between the components and the server device (e.g., “contained by” relationships) and relationships between the software applications and the server device (e.g., “runs on” relationships) may be represented as such in CMDB 500.

More generally, the relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

In this manner, remote network management platform 320 may discover and inventory the hardware and software deployed on and provided by managed network 300.

### B. Vertical Discovery

Vertical discovery is a technique used to find and map configuration items that are part of an overall service, such as a web service. For example, vertical discovery can map a web service by showing the relationships between a web server application, a LINUX® server device, and a database that stores the data for the web service. Typically, horizontal discovery is run first to find configuration items and basic relationships therebetween, and then vertical discovery is run to establish the relationships between configuration items that make up a service.

Patterns can be used to discover certain types of services, as these patterns can be programmed to look for specific arrangements of hardware and software that fit a description of how the service is deployed. Alternatively or additionally, traffic analysis (e.g., examining network traffic between devices) can be used to facilitate vertical discovery. In some cases, the parameters of a service can be manually configured to assist vertical discovery.

In general, vertical discovery seeks to find specific types of relationships between devices, components, and/or applications. Some of these relationships may be inferred from configuration files. For example, the configuration file of a web server application can refer to the IP address and port number of a database on which it relies. Vertical discovery patterns can be programmed to look for such references and infer relationships therefrom. Relationships can also be inferred from traffic between devices—for instance, if there is a large extent of web traffic (e.g., TCP port 80 or 8080) traveling between a load balancer and a device hosting a web server, then the load balancer and the web server may have a relationship.

Relationships found by vertical discovery may take various forms. As an example, an email service may include an email server software configuration item and a database application software configuration item, each installed on different hardware device configuration items. The email service may have a “depends on” relationship with both of these software configuration items, while the software configuration items have a “used by” reciprocal relationship with the email service. Such services might not be able to be fully determined by horizontal discovery procedures, and instead may rely on vertical discovery and possibly some extent of manual configuration.

### C. Advantages of Discovery

Regardless of how discovery information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

In another example, suppose that a database application is executing on a server device, and that this database application is used by an employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular hardware device fails.

In general, configuration items and/or relationships between configuration items may be displayed on a web-based interface and represented in a hierarchical fashion. Modifications to such configuration items and/or relationships in the CMDB may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

### VI. CMDB Identification Rules and Reconciliation

A CMDB, such as CMDB 500, provides a repository of configuration items and relationships. When properly provisioned, it can take on a key role in higher-layer applications deployed within or involving a computational instance. These applications may relate to enterprise IT service management, operations management, asset management, configuration management, compliance, and so on.

For example, an IT service management application may use information in the CMDB to determine applications and services that may be impacted by a component (e.g., a server device) that has malfunctioned, crashed, or is heavily loaded. Likewise, an asset management application may use information in the CMDB to determine which hardware and/or software components are being used to support particular enterprise applications. As a consequence of the importance of the CMDB, it is desirable for the information stored therein to be accurate, consistent, and up to date.

A CMDB may be populated in various ways. As discussed above, a discovery procedure may automatically store information including configuration items and relationships in the CMDB. However, a CMDB can also be populated, as a whole or in part, by manual entry, configuration files, and third-party data sources. Given that multiple data sources may be able to update the CMDB at any time, it is possible that one data source may overwrite entries of another data source. Also, two data sources may each create slightly different entries for the same configuration item, resulting in a CMDB containing duplicate data. When either of these occurrences takes place, they can cause the health and utility of the CMDB to be reduced.

In order to mitigate this situation, these data sources might not write configuration items directly to the CMDB. Instead, they may write to an identification and reconciliation application programming interface (API) of IRE 514. Then, IRE 514 may use a set of configurable identification rules to uniquely identify configuration items and determine whether and how they are to be written to the CMDB.

In general, an identification rule specifies a set of configuration item attributes that can be used for this unique identification. Identification rules may also have priorities so that rules with higher priorities are considered before rules with lower priorities. Additionally, a rule may be independent, in that the rule identifies configuration items independently of other configuration items. Alternatively, the rule may be dependent, in that the rule first uses a metadata rule to identify a dependent configuration item.

Metadata rules describe which other configuration items are contained within a particular configuration item, or the host on which a particular configuration item is deployed. For example, a network directory service configuration item may contain a domain controller configuration item, while a web server application configuration item may be hosted on a server device configuration item.

A goal of each identification rule is to use a combination of attributes that can unambiguously distinguish a configuration item from all other configuration items, and is expected not to change during the lifetime of the configuration item. Some possible attributes for an example server device may include serial number, location, operating system, operating system version, memory capacity, and so on. If a rule specifies attributes that do not uniquely identify the configuration item, then multiple components may be represented as the same configuration item in the CMDB. Also, if a rule specifies attributes that change for a particular configuration item, duplicate configuration items may be created.

Thus, when a data source provides information regarding a configuration item to IRE 514, IRE 514 may attempt to match the information with one or more rules. If a match is found, the configuration item is written to the CMDB or updated if it already exists within the CMDB. If a match is not found, the configuration item may be held for further analysis.

Configuration item reconciliation procedures may be used to ensure that only authoritative data sources are allowed to overwrite configuration item data in the CMDB. This reconciliation may also be rules-based. For instance, a reconciliation rule may specify that a particular data source is authoritative for a particular configuration item type and set of attributes. Then, IRE 514 might only permit this authoritative data source to write to the particular configuration item, and writes from unauthorized data sources may be prevented. Thus, the authorized data source becomes the single source of truth regarding the particular configuration item. In some cases, an unauthorized data source may be allowed to write to a configuration item if it is creating the configuration item or the attributes to which it is writing are empty.

Additionally, multiple data sources may be authoritative for the same configuration item or attributes thereof. To avoid ambiguities, these data sources may be assigned precedences that are taken into account during the writing of configuration items. For example, a secondary authorized data source may be able to write to a configuration item's attribute until a primary authorized data source writes to this attribute. Afterward, further writes to the attribute by the secondary authorized data source may be prevented.

In some cases, duplicate configuration items may be automatically detected by IRE 514 or in another fashion. These configuration items may be deleted or flagged for manual de-duplication.

### VII. Example Natural Language Models

A natural language model (e.g., a large language model, or “LLM”) is an advanced computational model, primarily functioning within the domain of natural language processing (“NLP”) and machine learning. An LLM can be configured to understand, interpret, generate, and respond to human language in a manner that is both contextually relevant and syntactically coherent. The underlying structure of an LLM is typically based on a neural network architecture, more specifically, a variant of the transformer model. Transformers are notable for their ability to process sequential data, such as text, with high efficiency.

The operation of an LLM involves layers of interconnected processing units, known as neurons, which collectively form a deep neural network. This network can be trained on vast datasets comprising text from diverse sources, thereby enabling the LLM to learn a wide array of language patterns, structures, and colloquial nuances for prose, poetry, and program code. The training process involves adjusting the weights of the connections between neurons using algorithms such as backpropagation, in conjunction with optimization techniques like stochastic gradient descent, to minimize the difference between the LLM's output and expected output.

An aspect of an LLM's functionality is its use of attention mechanisms, particularly self-attention, within the transformer architecture. These mechanisms allow the model to weigh the importance of different parts of the input text differently, enabling it to focus on relevant aspects of the data when generating responses or analyzing language. The self-attention mechanism facilitates the model's ability to generate contextually relevant and coherent text by understanding the relationships and dependencies between words or tokens in a sentence (or longer parts of texts), regardless of their position.

Upon receiving an input, such as a text query or a prompt, the LLM may process this input through its multiple layers, generating a probabilistic model of the language therein. It predicts the likelihood of each word or token that might follow the given input, based on the patterns it has learned during its training. The model then generates an output, which could be a continuation of the input text, an answer to a query, or other relevant textual content, by selecting words or tokens that have the highest probability of being contextually appropriate.

Furthermore, an LLM can be fine-tuned after its initial training for specific applications or tasks. This fine-tuning process involves additional training (e.g., with reinforcement from humans), usually on a smaller, task-specific dataset, which allows the model to adapt its responses to suit particular use cases more accurately. This adaptability makes LLMs highly versatile and applicable in various domains, including but not limited to, chatbot development, content creation, language translation, and sentiment analysis.

Some LLMs are multimodal in that they can receive prompts in formats other than text and can produce outputs in formats other than text. Thus, while LLMs are predominantly designed for understanding and generating textual data, multimodal LLMs extend this functionality to include multiple data modalities, such as visual and auditory inputs, in addition to text.

A multimodal LLM can employ an advanced neural network architecture, often a variant of the transformer model that is specifically adapted to process and fuse data from different sources. This architecture integrates specialized mechanisms, such as convolutional neural networks for visual data and recurrent neural networks for audio processing, allowing the model to effectively process each modality before synthesizing a unified output.

The training of a multimodal LLM involves multimodal datasets, enabling the model to learn not only language patterns but also the correlations and interactions between different types of data. This cross-modal training results in multimodal LLMs being adept at tasks that require an understanding of complex relationships across multiple data forms, a capability that text-only LLMs do not possess. This makes multimodal LLMs particularly suited for advanced applications that necessitate a holistic understanding of multimodal information, such as chatbots that can interpret and produce images and/or audio.

### VIII. Example Improved Generation and Provision of Workflow Guidance

Users may navigate a workflow (e.g., via a graphical user interface (GUI) provided in an internet browser or a purpose-built application) in order to perform a variety of tasks. For example, users could navigate to various different parts of a workflow in order to create new incident reports, take actions to address problems or concerns represented in incident reports (e.g., to correct a malfunction of a managed network that has been reported in an incident report), modify such incident reports (e.g., to reflect actions taken to fully or partially resolve a problem or concern), create new user accounts or modify privileges or other information related to such accounts, add and configure new software or hardware of a managed network, decommission or remove software or hardware of a managed network, generate reports or otherwise evaluate the functioning of aspects of a managed network, perform tasks relating to the contents or functioning of a database (e.g., a human resources database, an engineering database, a logistics database), or other actions related to the operation and configuration of a managed network or other technological system. The workflow may include a large number of configuration panels, readouts, resource listings, database interfaces, or other pages or other elements that the user can interact with and navigate between in order to accomplish the user's objectives.

Accordingly, a new user, a user engaging with new or updated aspects of a workflow, a user engaging with aspects of a workflow and/or objective with which they are unfamiliar, or some other user may experience difficulty in determining how to navigate the workflow in order to accomplish the user's objective(s). This can lead to the user inefficiently navigating the workflow (e.g., to pages of the workflow that are not relevant to the user's objective(s)), by repeated cycling back and forth through relevant pages of the workflow in order to determine the correct next step). This can lead to wasted processor cycles, communications bandwidth, database capacity, and/or other wasted computational resources as the user navigates the workflow inefficiently (e.g., due to a server generating and serving web pages to the user related to their navigation through the workflow). To guide the user, tutorial information may be made available to the user. However, the user may need to navigate away from the workflow in order to access such tutorial information, potentially losing progress toward their objective(s) and wasting computational resources to re-navigate the workflow to the point at which they consulted the tutorial information. Indeed, in some examples the navigation steps illustrated by the tutorial may differ from the navigation already performed by the user to the degree that the user must begin navigating the workflow from scratch, wasting the computational resources used by the user to partially navigate the workflow prior to consulting the tutorial.

Additionally, such documentation or tutorial information generally needs to have been created (e.g., by a human developer) prior to the user's need thereof. If such documentation has not been created for the particular user's particular task or problem, then the user will not be able to access any information to guide them to the completion of their task. This can result in task failure and/or further unnecessary expenditure of processing, bandwidth, or memory capacity or other computing resources as the user attempts to navigate the workflow without such guidance.

The embodiments described herein provide solutions to these technical problems by obtaining logs of prior navigations of the workflow (e.g., by other users) and using a subset of the logs (e.g., logs that satisfy an efficiency criterion) to generate navigational guidance for a user to assist in their current navigation of the workflow (e.g., by applying the subset of the logs as input to a natural language model or other model or algorithm). This guidance can then be provided to the user without their leaving their current navigation (e.g., as an overlay, tooltip, or other element presented in the same GUI as they are using to navigate the workflow), avoiding wasted computational resources from the user changing context to view a tutorial or re-navigating the workflow to conform so such a tutorial. The use of a natural language model or other model to generate such guidance also allows a wider variety of log data to be used (e.g., user-provided annotations regarding the user's experience or objective(s) in a given navigation, HTML or other textual code describing aspects of a user's navigation of the workflow and of the depicting or configuration of the workflow itself) as well as allowing user input to be added to the input log data to enhance the model output (e.g., allowing a user to specify their objective in the present workflow navigation).

In some examples, the navigational guidance can be generated and provided to the user in response to a determination that such guidance is needed, e.g., responsive to detecting that the user's in-progress navigation of the workflow meets an inefficiency criterion. This can reduce the computational cost of providing such guidance by only generating the guidance, and performing related functions (e.g., identifying a number of stored navigation logs (e.g., two or more) that match the user's current navigation, applying a set of logs to a natural language model or other model) when guidance is needed, as determined based on detecting that the user has not performed a navigation action in more than a threshold period of time, that the user is about to interact with a cancel or back button, or detecting some other activities evidencing that the user's in-progress navigation of the workflow meets the inefficiency criterion.

The portion of the workflow navigation logs used to generate the suggested navigation guidance can be further limited to a subset of the available logs that matches the user's current navigation (e.g., that matches one, two, five, or more of the user's most recent steps in their navigation of the workflow). In this way, the guidance can be tailored to the user's specific workflow navigation (e.g., based on subsequent navigation steps historically taken by other users who engaged in the same prior navigation steps), allowing the user to continue directly from their current navigation without, e.g., backtracking or sacrificing already-performed steps in order to comport the user's navigation with a tutorial or other pre-generated guidance information which may or may not match the user's current navigation of the workflow. This allows the guidance to be tailored specifically to the user's current navigation of the workflow while being informed by one or more users' past, similar navigations of the workflow. Additionally, by generating the guidance based on and responsive to the current user's specific navigation of the workflow, the computational cost to, e.g., generate and store tutorial or other guidance information for every possible navigation of the workflow, which may be prohibitively large for even simple workflows, can be avoided. Additionally, restricting the amount of such log info used to generate the navigation guidance can allow simpler, smaller, or otherwise computationally less expensive models or algorithms to be used (e.g., to use a natural language model with a smaller input size to be used, since the number of logs applied thereto to generate the guidance has been limited).

Suggested navigation information generated via the methods described herein can be indicated to a user in a variety of ways. For example, where the user is navigating the workflow via a GUI, one or more outputs overlaying the GUI could be provided to indicate the suggested navigation information. This could include providing a tooltip, text box, arrow, modal dialog, or other output on the GUI. The output (e.g., modal dialog, tooltip, popup) could be located proximate to or otherwise graphically indicate an element of the GUI that the user should interact with (e.g., click, select, enter text into, or otherwise interact with a button, text box, slider, or other GUI element). The output overlaid on or in the GUI could include text, e.g., text informing the user of a suggested navigational or other action to take and/or text explaining the context or reason to perform a suggested navigation action.

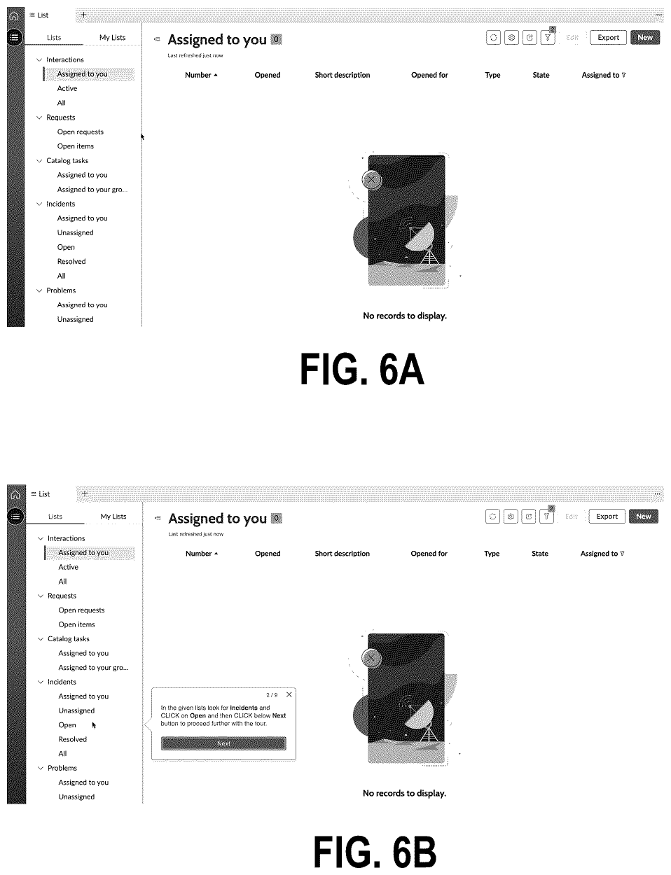

For example, FIG. 6A depicts an example page of a a workflow that is being navigated, by a user, using the depicted GUI. Logs of past navigations of the workflow could be used (e.g., two or more logs satisfying an efficiency criterion and matching at least two, or at least five, prior steps of the user's in-progress navigation of the workflow) to generate suggested navigation information related to the workflow (e.g., in response to determining that the user has taken too long to continue their navigation or some other indicator that the in-progress navigation of the workflow meets an inefficiency criterion). This suggested navigation information can then be indicated to the user via the GUI. As shown in FIG. 6B, this can take the form of an overlay that can indicate the location of an element of the GUI that the user is suggested to interact with (in this example, to click the “Open” button under the “Incidents” grouping in order to proceed with creating a new incident report). Such an overlay can include textual or other information providing context or other instructions related to the suggested navigation information (in this example, to press the indicated button). In some examples, the overlay could be a modal dialog, e.g., as depicted in FIG. 6B, requiring the user to interact with the overlay in some manner (in this example, to dismiss the overlay by clicking the “x” or to proceed with a ‘next step’ in the suggested navigation information by clicking “Next”) in order to dismiss the overlay and continue interacting with the GUI.

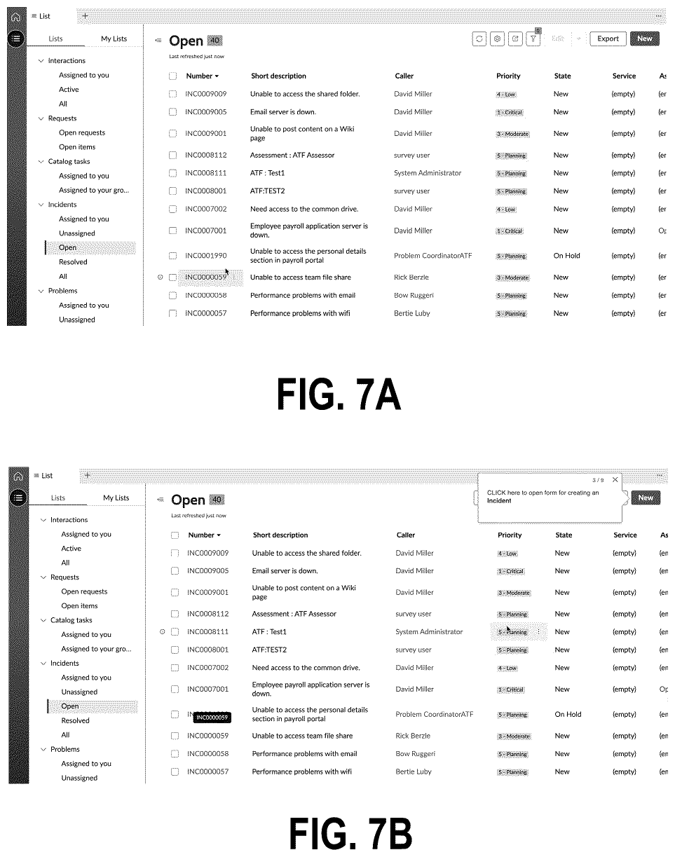

In another example, FIG. 7A depicts another example page of the workflow that is being navigated, by the user, using the depicted GUI after clicking the “Open” button depicted in FIG. 6B. This page depicts a number of already-existing incident reports, along with relevant information (“Short description,” “Number,” Caller,” etc.) and the ability to select, open, or otherwise interact with the existing incident reports. As described in relation to FIG. 6A, logs of past navigations of the workflow could be used to generate additional suggested navigation information related to the workflow. This suggested navigation information can then be indicated to the user via the GUI. As shown in FIG. 7B, this can take the form of an overlay that can indicate the location of an element of the GUI that the user is suggested to interact with (in this example, to click the “New” button at the top right of the page in order to proceed with creating a new incident report). Such an overlay can include textual or other information providing context or other instructions related to the suggested navigation information (in this example, to press the indicated button). In some examples, the overlay could be a modal dialog, e.g., as depicted in FIG. 6B, requiring the user to interact with the overlay in some manner (in this example, to dismiss the overlay by clicking the “x”) in order to dismiss the overlay and continue interacting with the GUI.

As noted above, suggested navigation information can be generated and presented to a user in response to the user explicitly requesting such guidance, in response to the user's in-progress navigation of the workflow meeting an inefficiency criterion, or in response to some other condition. Determining that the user's in-progress navigation of the workflow meets an inefficiency criterion can include a variety of determinations based on a variety of factors. For example, determining that the user's in-progress navigation of the workflow meets an inefficiency criterion can include determining that the user has not provided an input to or navigated between pages of the workflow for more than a threshold period of time (e.g., one minute, thirty seconds, ten seconds) or exhibited delay in some other manner. In some examples, determining that the user's in-progress navigation of the workflow meets an inefficiency criterion can include determining that the user is about to interact with an aspect of a graphical user interface that causes the graphical user interface to cancel the workflow, to cancel an in-progress process (e.g., incident report generation) of the workflow, to access tutorial information, to return to a prior step of the in-progress navigation of the workflow, to change repeatedly between a GUI presenting the workflow and some other GUI (e.g., a browser to search the internet for guidance, between a tab of a browser being used to navigate the workflow and another tab of the browser), or to otherwise navigate within, to, and/or from the workflow in a manner indicative of user confusion.

The suggested navigation information can be determined based on one or more logs indicating navigational information regarding past navigations of the workflow. To provide improved results and reduce the computational cost of generating the suggested navigation information (by reducing the number of logs accessed, analyzed, applied as inputs to a natural language model, or otherwise processed or manipulated to generate the guidance information), a subset of the available logs that satisfy an efficiency criterion could be identified and used to generate the suggested navigation information. This could include identifying logs that are related to one or more particular goals detected for the user's in-progress navigation of the workflow and that attain those goal(s) using an absolutely or relatively small number of steps. For example, the logs could be limited to those that include less than a threshold number of steps. Additionally or alternatively, the logs could be limited to logs that, amongst the set of logs related to the particular goal(s), are less than a specified percentile with respect to number of steps.

Additionally or alternatively, a subset of the available logs that match the user's in-progress navigation of the workflow could be identified and used to generate the suggested navigation information. This could include the identified logs matching the user's in-progress navigation with respect to one, two, five, or some other number of prior pages or other navigational steps through the workspace. For example, to generate the suggested navigation information depicted in FIG. 7B, a set of logs that include a navigation step at the “Assigned to you” page depicted in FIG. 6A followed by the “Open Incident” page depicted in FIG. 7A could be identified and used to determine the suggested navigation information (e.g., to determine a next page to which to navigate).

The user's in-progress navigation ‘matching’ a stored navigation log with respect to one or more steps could include matching with respect to navigation along a number of the same pages of the workflow, selecting the same interface elements (e.g., buttons, sliders, text input boxes) of pages of the workflow, or matching with respect to some other aspect of interacting with elements of and/or navigating between pages of the workflow. The logs could represent a navigation, in whole or in part, as an ordered sequence of pages (and/or other navigational actions, e.g., button presses) that could be compared to a record of the sequence of pages of the user's in-progress navigation to determine whether at least a threshold number (e.g., two or more, five or more) of the user's most recent pages match a corresponding ordered sequence of pages in the logs.

A step of the user's in-progress navigation ‘matching’ a step of a logged navigation could include the steps corresponding to the same page (e.g., the same “Assigned to you” page or the same “Open Incident” page) of a GUI used to interact with the workflow. Such pages could be identified by respective universally unique identifiers (UUIDs) and obtaining logs indicating navigational information regarding prior navigations of the workflow that match at least two (or more, e.g., five) steps of the user's in-progress navigation of the workflow could include obtaining logs that include sequences of universally unique identifiers that match at least the UUIDs identifying the pages corresponding to at least two (or more, e.g., five) most recent steps of the user's in-progress navigation of the workflow. Such UUIDs could be uniform resource locators (URLs) used by a browser to request, from a server or other remote system, corresponding pages of the workflow that are uniquely identified by at least a portion of the URL (e.g., one portion of the URL could uniquely identify the page, while another portion could represent user credential data, user history data, user-specific page content or status metadata, or other information in addition to the information needed to identify the page of the workflow).

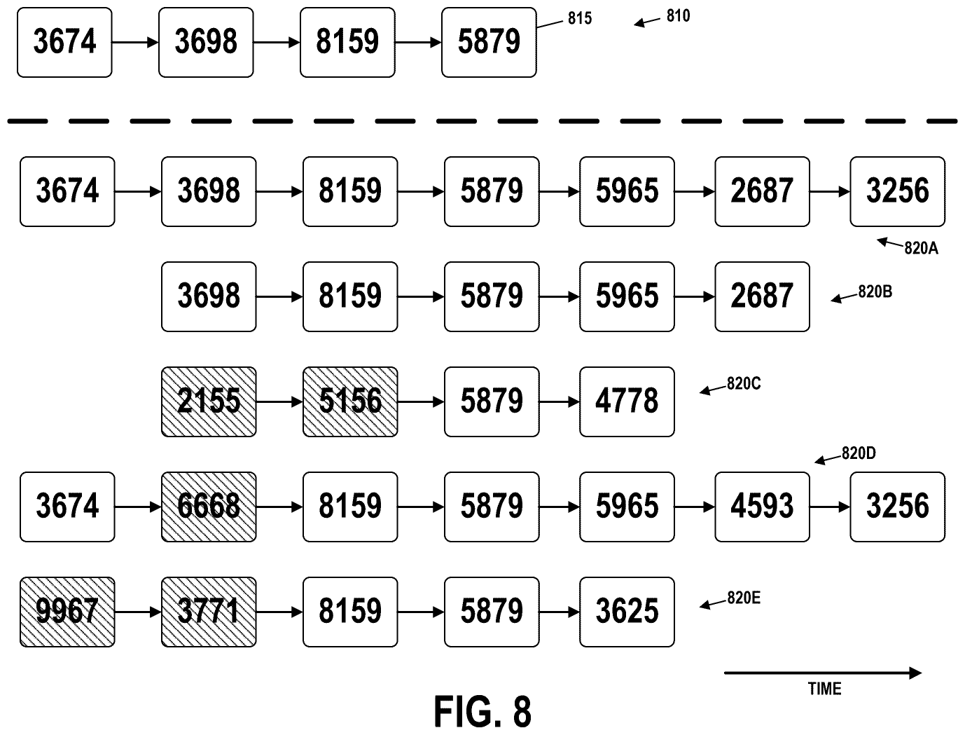

FIG. 8 schematically depicts a user's in-progress navigation of a workflow 810 as a sequence of steps (in particular, as a sequence of pages identified by respective four-digit UUIDs), with the user's most recent step 815 represented by UUID ‘5879.’ Also depicted (beneath the horizontal dashed line) are logged past navigations 820A-E of the workflow that all include the same page as the user's most recent step 815 and that have been aligned, with respect to time, to the user's most recent step 815. The logged past navigations 820A-E also include a number of steps beyond the user's most recent step 815. Identifying a set of the logs to use to generate suggested navigation information could include identifying a subset of the logs that match at least two steps of the user's in-progress navigation of the workflow (i.e., 820A, 820B, 820D, 820E) or more steps (e.g., at least five) of the user's in-progress navigation of the workflow (e.g., at least three, selecting 820A and 820B).

Logs identified as sufficiently matching the user's in-progress navigation could be further filtered by including only a subset of the matching logs that also satisfy an efficiency criterion, e.g., that have an absolutely or relatively small number of total steps and/or number of remaining steps after the step corresponding to the user's current step 815. For example, amongst the logs that match at least two steps (e.g., at least five steps) of the user's in-progress navigation of the workflow, logs having less than a threshold number of total steps (e.g., 820B and 820E if that threshold was five) or less than a threshold number of remaining steps (e.g., 820E if that threshold was one) would be used. Additionally or alternatively, amongst the logs that match at least two steps (e.g., at least five steps) of the user's in-progress navigation of the workflow, logs that are, with respect to number of total steps, less than a threshold percentile (e.g., 820B and 820E if that threshold was 50%) or logs that are, with respect to number of remaining steps, less than a threshold percentile (e.g., 820E if that threshold was 25%) would be used.

The use of a UUID (e.g., a URL) to compare steps of the user's current navigation and steps of past logged navigations of the workflow can provide a significant computational benefit, since such identifiers can be easily and quickly stored and compared without significant computational effort (compared to, e.g., storing an image, page HTML, or other data indicative of the steps, which are larger and may differ from navigation to navigation, requiring more computationally expensive comparison operations). Additionally, sequences of such UUIDs can be hashed or otherwise manipulated to further reduce the cost of identifying stored logs that match the user's in-progress navigation with respect to two (or some other specified number, e.g., five) previous steps. For example, a subset of available logs could be identified that include instances of the UUID corresponding to the user's current step and then only that identified subset of logs could be further searched and analyzed for instances of that step that are also immediately preceded by the step immediately preceding the user's current step in the user's in-progress navigation. This can have the effect of reducing the computational cost to identify logs, from the set of available logs, that include sub-sequences of steps that match the immediately prior two (or three, or five, or more) steps of the user's in-progress navigation.

Using such an identified set of stored logs to generate suggested navigation information to guide the user's future navigation could accomplished in a variety of ways. For example, a ‘next’ step for the user to take could be determined statistically as the mode or some other summary of the set of next steps of the identified subset of the logs. For example, in reference to FIG. 8, if the subset of logs are identified based on matching the user's in-progress navigation with respect to two (or five, or more) previous steps (i.e., 820A, 820B, 820D, and 820E), then the suggested navigation information could be determined to indicate to the user to navigate to the page with the UUID “5965” (since three of the four matching logs have, as their next step, the page with the UUID “5965”). Additionally or alternatively, the set of identified logs, or a subset thereof, could be applied as inputs to a natural language model (optionally as part of a prompt requesting suggested navigation information based thereon, a preferred format of such navigation information, a record of the prior steps of the user's in-progress navigation, a request for guidance or other textual input from the user). The natural language model (e.g., an LLM) could then output the suggested navigation information, which could then be indicated (e.g., as a tooltip, modal dialog, and/or overlay in a GUI) to the user.

The use of a natural language model in this manner provides a variety of technical benefits. For example, the use of a natural language model allows any user input (e.g., textural requests for guidance toward a specific task) regarding their objective can be easily appended to the identified stored navigation logs in order to readily, and with minimal additional computational cost or modification of the natural language model or the format of its input, improve the suggested navigation information generate thereby. Additionally, such a natural language model can be instructed to output the suggested navigation information in a specified format, e.g., an amount of HTML code that can be added to the HTML code that defines the page that the user has currently navigated to. This can allow such suggested navigation information to be easily and with minimal computational cost added to the HTML of the user's current page and served to the browser being used by the user to navigate the workflow. Additionally or alternatively, the model can be instructed to output the suggested navigation information in a format that specifies the location, type (e.g., modal, non-modal), textual contents, or other aspects of the GUI representation of the suggested navigation information.

### IX. Example Operations

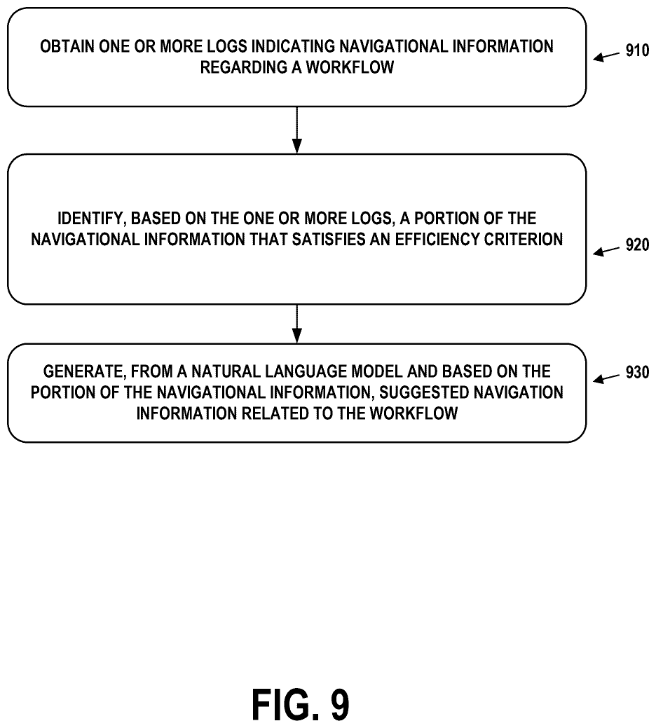

FIG. 9 is a flow chart illustrating an example embodiment. The process illustrated by FIG. 9 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 9 may be simplified by the removal of any one or more of the features shown therein. Further, these embodiments may be combined with features, aspects, and/or implementations of any of the previous figures or otherwise described herein.

The embodiments of FIG. 9 include obtaining one or more logs indicating navigational information regarding a workflow (910). This could include obtaining logs (e.g., at least two logs) indicating navigational information regarding prior navigations of the workflow that match at least two steps (e.g., at least five steps) of an in-progress navigation of the workflow. Limiting the logs to those that match at least two (or more, e.g., at least five) steps of the in-progress navigation of the workflow can reduce the computational cost of executing a natural language model to generate guidance or other navigation information since, by limiting the amount of input logs provided to the model, the model can be smaller (e.g., fewer parameters, a shorter input history), thus reducing the processor cycles and memory needed to execute the model and reducing the storage space and bandwidth needed to store and recall the model. In some examples, steps of the in-progress navigation of the workflow could correspond to pages of a graphical user interface that are identified by respective universally unique identifiers and the one or more logs indicating navigational information regarding the workflow could include respective sequences of universally unique identifiers identifying respective pages of the graphical user interface. In such examples, obtaining logs (e.g., at least two logs) indicating navigational information regarding prior navigations of the workflow that match at least two steps (e.g., at least five steps) of the in-progress navigation of the workflow could include obtaining logs that include sequences of universally unique identifiers that match at least the universally unique identifiers identifying the pages corresponding to at least two most recent steps of the in-progress navigation of the workflow.

The embodiments of FIG. 9 additionally include identifying, based on the one or more logs, a portion of the navigational information that satisfies an efficiency criterion (920). This provides a benefit of reducing the computational cost (e.g., processor cycles, memory, database bandwidth) of generating guidance or other navigation information by limiting the logs used to generate such information to that subset of the available logs that satisfies the efficiency criterion. This can also reduce the computational cost of executing a natural language model to generate such information since, by limiting the amount of input logs provided to the model, the model can be smaller (e.g., fewer parameters, a shorter input history), thus reducing the processor cycles and memory needed to execute the model and reducing the storage space and bandwidth needed to store and recall the model. Identifying the portion of the navigational information that satisfies the efficiency criterion could include at least one of (i) identifying at least one log of the one or more logs that is related to a first particular goal and that includes less than a threshold number of steps or (ii) identifying at least one log of the one or more logs that includes a number of steps that is less than a specified percentile among a subset of the one or more logs that are related to a second particular goal.

The embodiments of FIG. 9 yet further include generating, from a natural language model and based on the portion of the navigational information, suggested navigation information related to the workflow 930.

The embodiments of FIG. 9 may include additional or alternative steps of features. For example, the embodiments of FIG. 9 may additionally include generating one or more outputs indicating the suggested navigation information. In such examples, navigation of the workflow could be by way of a graphical user interface. In such examples, generating one or more outputs indicating the suggested navigation information could include generating one or more outputs overlaying part of the graphical user interface.

The embodiments of FIG. 9 may additionally include determining that an in-progress navigation of the workflow meets an inefficiency criterion, and identifying the portion of the navigational information that satisfies the efficiency criterion and generating the suggested navigation information related to the workflow could be performed responsive to determining that the in-progress navigation of the workflow meets the inefficiency criterion. This could reduce processor cycles, memory, bandwidth, or other computational costs of implementing the embodiments of FIG. 9 by avoiding the computational costs of those steps unless the generation of the guidance is indicated as potentially beneficial by the in-progress navigation of the workflow meeting the inefficiency criterion. In such embodiments, obtaining one or more logs indicating navigational information regarding the workflow could include obtaining logs indicating navigational information regarding prior navigations of the workflow that match at least two steps (or more, e.g., at least five) of an in-progress navigation of the workflow. Determining that the in-progress navigation of the workflow meets the inefficiency criterion could include (i) determining that a user has not provided an input to or navigated between pages of the workflow for more than a threshold period of time; (ii) determining that a user is about to interact with an aspect of a graphical user interface that causes the graphical user interface to cancel the workflow or to return to a prior step of the in-progress navigation of the workflow; or (iii) some other determination.

### X. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of non-transitory computer readable medium such as a storage device including RAM, ROM, a disk drive, a solid-state drive, or another tangible storage medium.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method comprising:
obtaining one or more logs indicating navigational information regarding a workflow;
identifying, based on the one or more logs, a portion of the navigational information that satisfies an efficiency criterion; and
generating, from a natural language model and based on the portion of the navigational information, suggested navigation information related to the workflow.

2. The method of claim 1, further comprising:
generating one or more outputs indicating the suggested navigation information.

3. The method of claim 2, wherein navigation of the workflow is by way of a graphical user interface.

4. The method of claim 3, wherein generating one or more outputs indicating the suggested navigation information comprises generating one or more outputs overlaying part of the graphical user interface.

5. The method of claim 1, further comprising:
determining that an in-progress navigation of the workflow meets an inefficiency criterion, wherein identifying the portion of the navigational information that satisfies the efficiency criterion and generating the suggested navigation information related to the workflow are performed responsive to determining that the in-progress navigation of the workflow meets the inefficiency criterion.

6. The method of claim 5, wherein determining that the in-progress navigation of the workflow meets the inefficiency criterion comprises determining that a user has not provided an input to or navigated between pages of the workflow for more than a threshold period of time.

7. The method of claim 5, wherein determining that the in-progress navigation of the workflow meets the inefficiency criterion comprises determining that a user is about to interact with an aspect of a graphical user interface that causes the graphical user interface to cancel the workflow or to return to a prior step of the in-progress navigation of the workflow.

8. The method of claim 5, wherein obtaining one or more logs indicating navigational information regarding the workflow comprises obtaining logs indicating navigational information regarding prior navigations of the workflow that match at least two steps of the in-progress navigation of the workflow.

9. The method of claim 1, wherein obtaining one or more logs indicating navigational information regarding the workflow comprises obtaining logs indicating navigational information regarding prior navigations of the workflow that match at least two steps of an in-progress navigation of the workflow.

10. The method of claim 9, wherein steps of the in-progress navigation of the workflow correspond to pages of a graphical user interface that are identified by respective universally unique identifiers, wherein the one or more logs indicating navigational information regarding the workflow include respective sequences of universally unique identifiers identifying respective pages of the graphical user interface, and wherein obtaining logs indicating navigational information regarding prior navigations of the workflow that match at least two steps of the in-progress navigation of the workflow comprises obtaining logs that include sequences of universally unique identifiers that match at least the universally unique identifiers identifying the pages corresponding to at least two most recent steps of the in-progress navigation of the workflow.

11. The method of claim 1, wherein identifying the portion of the navigational information that satisfies the efficiency criterion comprises at least one of (i) identifying at least one log of the one or more logs that is related to a first particular goal and that includes less than a threshold number of steps or (ii) identifying at least one log of the one or more logs that includes a number of steps that is less than a specified percentile among a subset of the one or more logs that are related to a second particular goal.

12. A non-transitory computer-readable medium, having stored thereon program instructions that, upon execution by a computing system, cause the computing system to perform operations comprising:
obtaining one or more logs indicating navigational information regarding a workflow;
identifying, based on the one or more logs, a portion of the navigational information that satisfies an efficiency criterion; and
generating, from a natural language model and based on the portion of the navigational information, suggested navigation information related to the workflow.

13. The non-transitory computer-readable medium of claim 12, wherein the operations further comprise:
generating one or more outputs indicating the suggested navigation information, wherein navigation of the workflow is by way of a graphical user interface, and wherein generating one or more outputs indicating the suggested navigation information comprises generating one or more outputs overlaying part of the graphical user interface.

14. The non-transitory computer-readable medium of claim 12, wherein the operations further comprise:
determining that an in-progress navigation of the workflow meets an inefficiency criterion, wherein identifying the portion of the navigational information that satisfies the efficiency criterion and generating the suggested navigation information related to the workflow are performed responsive to determining that the in-progress navigation of the workflow meets the inefficiency criterion.

15. The non-transitory computer-readable medium of claim 14, wherein determining that the in-progress navigation of the workflow meets the inefficiency criterion comprises at least one of: (i) determining that a user has not provided an input to or navigated between pages of the workflow for more than a threshold period of time or (ii) determining that a user is about to interact with an aspect of a graphical user interface that causes the graphical user interface to cancel the workflow or to return to a prior step of the in-progress navigation of the workflow.

16. The non-transitory computer-readable medium of claim 14, wherein obtaining one or more logs indicating navigational information regarding the workflow comprises obtaining logs indicating navigational information regarding prior navigations of the workflow that match at least two steps of the in-progress navigation of the workflow.

17. A system comprising:
one or more processors; and
memory, containing program instructions that, upon execution by the one or more processors, cause the system to perform operations comprising:
obtaining one or more logs indicating navigational information regarding a workflow;
identifying, based on the one or more logs, a portion of the navigational information that satisfies an efficiency criterion; and
generating, from a natural language model and based on the portion of the navigational information, suggested navigation information related to the workflow.

18. The system of claim 17, wherein the operations further comprise:
determining that an in-progress navigation of the workflow meets an inefficiency criterion, wherein identifying the portion of the navigational information that satisfies the efficiency criterion and generating the suggested navigation information related to the workflow are performed responsive to determining that the in-progress navigation of the workflow meets the inefficiency criterion.

19. The system of claim 18, wherein determining that the in-progress navigation of the workflow meets the inefficiency criterion comprises at least one of: (i) determining that a user has not provided an input to or navigated between pages of the workflow for more than a threshold period of time or (ii) determining that a user is about to interact with an aspect of a graphical user interface that causes the graphical user interface to cancel the workflow or to return to a prior step of the in-progress navigation of the workflow.

20. The system of claim 18, wherein obtaining one or more logs indicating navigational information regarding the workflow comprises obtaining logs indicating navigational information regarding prior navigations of the workflow that match at least two steps of the in-progress navigation of the workflow.
